(19) United States
(12) Patent Application Publication
(10) Pub. No.: US 2003/0133651 A1
(43) Pub. Date: Jul. 17, 2003

(54) Filtering noise in optical signal transmission

(75) Inventors: Farhad Hakimi, Watertown, MA (US); Hosain Hakimi, Watertown, MA (US)

Correspondence Address: HALE AND DORR, LLP, 60 STATE STREET, BOSTON, MA, 02109

(73) Assignee: TeraPhase Technologies, Inc., Waltham, MA (US)

(21) Appl. No.: 10/138,808

(22) Filed: May 3, 2002

Related U.S. Application Data
(63) Continuation-in-part of application No. 10/052,868, filed on Jan. 16, 2002.
(63) Continuation-in-part of application No. 10/053,478, filed on Jan. 16, 2002.
(63) Continuation-in-part of application No. 10/050,635, filed on Jan. 16, 2002.
(63) Continuation-in-part of application No. 10/050,751, filed on Jan. 16, 2002.
(63) Continuation-in-part of application No. 10/050,641, filed on Jan. 16, 2002.
(63) Continuation-in-part of application No. 10/050,749, filed on Jan. 16, 2002.
(60) Provisional application No. 60/356,072, filed on Feb. 11, 2002.
(60) Provisional application No. 60/354,721, filed on Feb. 5, 2002.

(51) Int. Cl. G02B 6/26

(52) U.S. Cl. 385/27

(57) ABSTRACT

An optical signal is transmitted, optically amplified, optically filtered, and received. The optical filtering rejects optical noise such as Amplified Spontaneous Emission noise and is configured to pass a single side band optical signal, and multimode filtering may be applied. A change in the optical signal may be detected, and the characteristics of the optical filtering may be altered based on the detected change.

### CROSS-REFERENCE TO RELATED APPLICATIONS

This application claims the benefit of U.S. Provisional Application No. 60/354,721, entitled “SSB SOLITON AND DISPERSION MANAGED SOLITON TRANSMISSION” filed on Feb. 5, 2002, which is incorporated herein by reference in its entirety. This application claims the benefit of U.S. Provisional Application No. 60/356,072, entitled “A FIBER OPTIC AUTO WAVELENGTH TRACKING FILTER FOR OPTICAL REGENERATORS AND RECEIVERS” filed on Feb. 11, 2002, which is incorporated herein by reference in its entirety.

This application is a continuation-in-part of U.S. patent application Ser. No. 10/052868, filed Jan. 16, 2002; U.S. patent application Ser. No. 10/053478, filed Jan. 16, 2002; U.S. patent application Ser. No. 10/050635, filed Jan. 16, 2002; U.S. patent application Ser. No. 10/050751, filed Jan. 16, 2002; U.S. patent application Ser. No. 10/050641, filed Jan. 16, 2002; and U.S. patent application Ser. No. 10/050749, filed Jan. 16, 2002, all of which are incorporated herein by reference in their entirety.

### BACKGROUND OF THE INVENTION

1. Field of the Invention

This invention relates to filtering noise in optical signal transmission.

2. Discussion of Related Art

Transmission of data over long distances, especially transoceanic telephone transmission, is increasingly effected optically using optical fibers. This has significant advantages compared to electrical transmission; in particular losses are low and there is less signal distortion. In such telecommunication systems, in particular for undersea telecommunications, there is a need for longer range optical signal transmission without degrading signal quality while remaining within reasonable cost limits.

Optical data signals traveling in optical fibers must be amplified at points along the way in order to compensate for the intrinsic attenuation losses of fiber. Such amplification in today's systems is accomplished by using Raman- or Erbium-Doped Fiber Amplifiers (EDFA).

The process of signal amplification is imperfect. Amplifiers such as EDFAs boost the signals but also add noise known as Amplified Spontaneous Emission (ASE). The spectrum of this noise is broadband, typically 30 nm in wavelength domain, and constitutes a background white noise for the signal spectrum. As a typical fiber optic link usually needs an optical amplifier every 50 or 100 km, a 1000 km link will contain approximately 10 to 20 EDFAs. The accumulation of noise generated by EDFAs can be a problem, as most optical data transmission links are ultimately limited by ASE noise.

One common way to reduce the ASE noise in optical links is to insert a narrow pass-band optical filter at (e.g., after) each of some or all of the amplifiers in the line. The filter is narrow enough to allow signal spectrum to pass while rejecting most of the ASE noise. FIG. 1 illustrates a typical case in which a Double Side Band (DSB) 10 Gb/s return-to-zero (RZ) data channel occupies approximately 25 GHz (0.2 nm) as signal spectrum, and a 100 GHz (0.8 nm FWHM (Full-Width Half-Maximum)) pass band filter is applied to reduce ASE noise. The data channel's spectrum usage is depicted as rectangle 110 and the filter's spectral effect is depicted as a dome shape (“dome”) 112 centered or nearly centered around the optical carrier (OC) frequency of the signal spectrum (the dome not necessarily having any particular characteristics other than a high point with sides extending outward and downward from the high point).

### SUMMARY OF THE INVENTION

The invention provides a system and methods for filtering noise in optical signal transmission. In certain embodiments, the invention provides a system and method for fiber optic auto wavelength tracking and filtering for optical regenerators and receivers.

According to one or more aspects of the invention, an optical signal is transmitted, optically amplified, optically filtered, and received. The optical filtering rejects optical noise such as Amplified Spontaneous Emission noise and is configured to pass a single side band optical signal, and multimode filtering may be applied. A change in the optical signal may be detected, and the characteristics of the optical filtering may be altered based on the detected change.

### BRIEF DESCRIPTION OF THE DRAWINGS

FIGS. 1-3 are spectral diagrams illustrating pass bands; and

FIGS. 4-8 are block diagrams of optical signal filtering systems according to certain embodiments of the invention.

### DETAILED DESCRIPTION

The present invention provides improved systems and methods for transmitting optical signals. Among other things, preferred embodiments of the invention include optical regenerators or receivers having noise filtering systems that, in certain embodiments, detect a change in the optical signals (the change possibly being gradual, as in the case of OC wander) and adapt in response to the change.

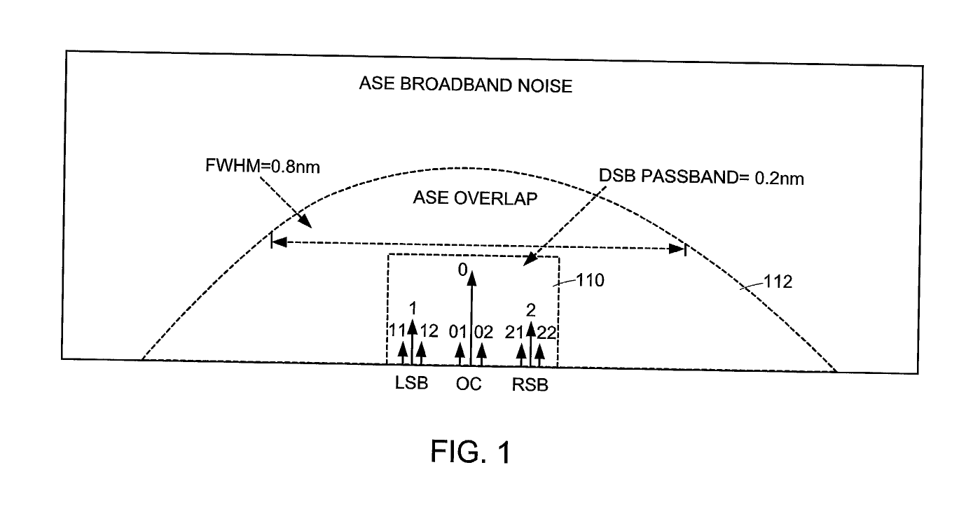

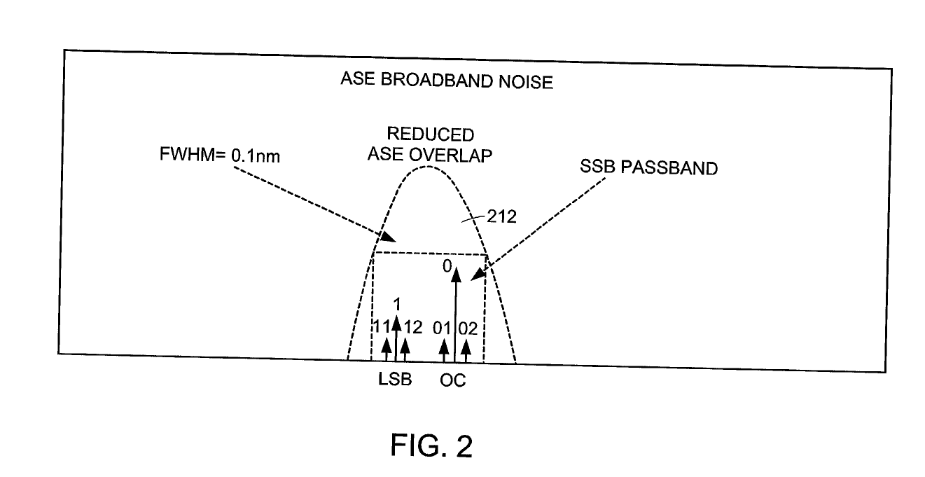

As optical fiber spans are increasing in distance and optical carriers intend to send signals in excess of 4000 km, it is useful to provide narrower pass band filters for the reduction of ASE. As shown in FIG. 2, at 10 Gb/s, the pass band of the filter can be narrowed to 0.1 nm FWHM as depicted by dome 212 that is narrower than dome 112 of FIG. 1 (as noted above, each dome does not necessarily have any particular characteristics other than a high point with sides extending outward and downward from the high point). In fact, the pass band of the filter may be narrow enough to permit only one data side band of the data channel to pass or to allow Single Side Band (SSB) reception at the receiver to improve the signal to noise ratio of the system. As shown in FIG. 1, pass band dome 112 allows passage of all spectral components of the data channel, including OC “0”, left side band (LSB) “1”, and right side band (RSB) “2”, and respective data side band pairs “01”-“02”, “11”-“12”, and “21”-“22”. As shown in FIG. 2, the center of pass band dome 212 is offset to the left of OC “0” and dome 212 is narrower than dome 112 such that pass band dome 212 eliminates RSB “2” and its data side band pair “21”-“22”, and allows passage of an SSB signal having OC “0” and LSB “1” and respective data side band pairs “01”-“02” and “11”-“12”.

The use of the narrower pass band reduces the amount by which the ASE overlaps the signal pass band. Furthermore, tight pass band filtering is beneficially applicable to many or all spectrally efficient schemes such as Carrier Suppressed RZ (CSRZ) or SSB. Removal of any redundant spectral components, through filtering, in data signals lowers ASE and simultaneously increases the modulation efficiency. In addition, narrow pass band filtering reduces the required pump power in EDFA and Raman amplification processes. This is shown in FIG. 2, in which a narrower pass band filter is used to remove redundant spectral components in the data signals and to further reduce ASE overlap.

Optical transmitter center frequencies (or wavelengths) are not completely stable and often vary in the range of ±25 GHz (±0.2 nm), which can complicate or hinder the use of fixed range narrow band filters. A variance in the center frequency may cause the narrow band filter to be excessively or inadequately offset with respect to the transmitted signal and to thereby improperly cut off desirable signal such as leftmost band “11” or rightmost band “02” of FIG. 2.

It is desirable to provide a stable, narrow-band filter that helps to avoid ASE noise accumulation.

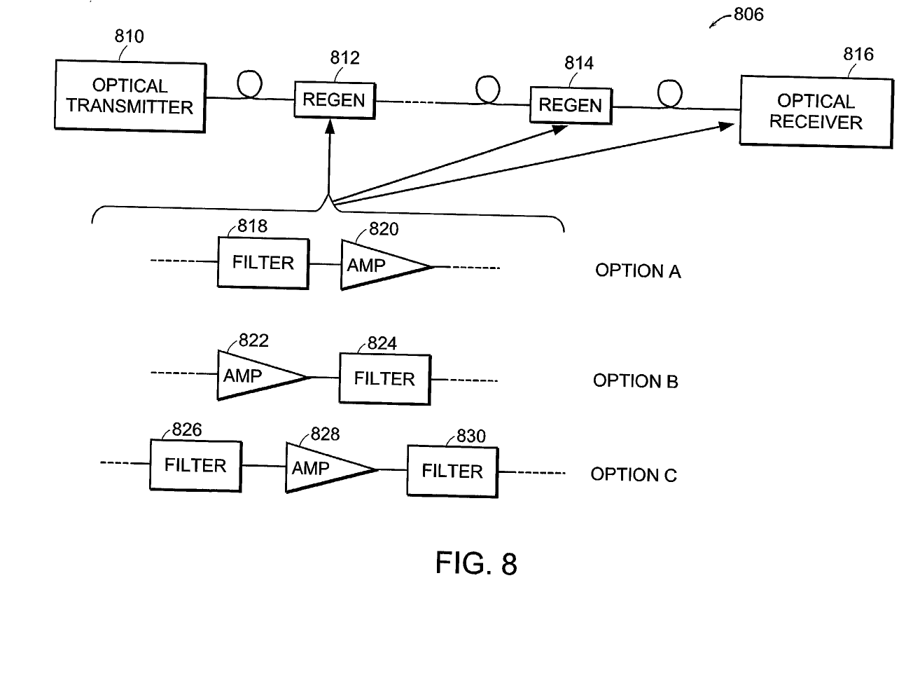

FIG. 8 illustrates an embodiment of the present invention in which an example optical transmission system 806 includes an optical transmitter 810 that transmits optical signals via regenerators including regenerators 812, 814 to optical receiver 816. One or more of the regenerators and/or receiver 810 may include optical filter/optical amplifier combinations such as options A, B, C as illustrated and now described. In the case of option A, optical filter 818 receives and acts upon the optical signals before the optical signals reach optical amplifier 820. In the case of option B, optical amplifier 822 receives and acts upon the optical signals before the optical signals reach optical filter 824. In the case of option C, optical filter 826 receives and acts upon the optical signals before the optical signals reach optical amplifier 828, which receives and acts upon the optical signals before the optical signals reach optical amplifier 830. One or more of filters 818, 824, 828, 826, 830 may have characteristics, including ASE noise rejection characteristics, as described below.

In a case in which a receiver such as receiver 810 includes one or more of the filter/amplifier combinations described above, the one or more combinations may be positioned to act upon the optical signal before the optical signal reaches a demodulator or a photodetector in the receiver.

In order to maximize ASE noise rejection for a variety of data formats (e.g. SSB, CSRZ or DSB) of long haul optical fiber links, an optical pass band filter (which may serve as one or more of the filters of FIG. 8) is provided to address wavelength or frequency shift or wander of the transmitters in optical link. Moreover, in at least some embodiments, the filtering action can further be improved to remove ASE components within the signal pass band itself and thus further reject the ASE within the pass band.

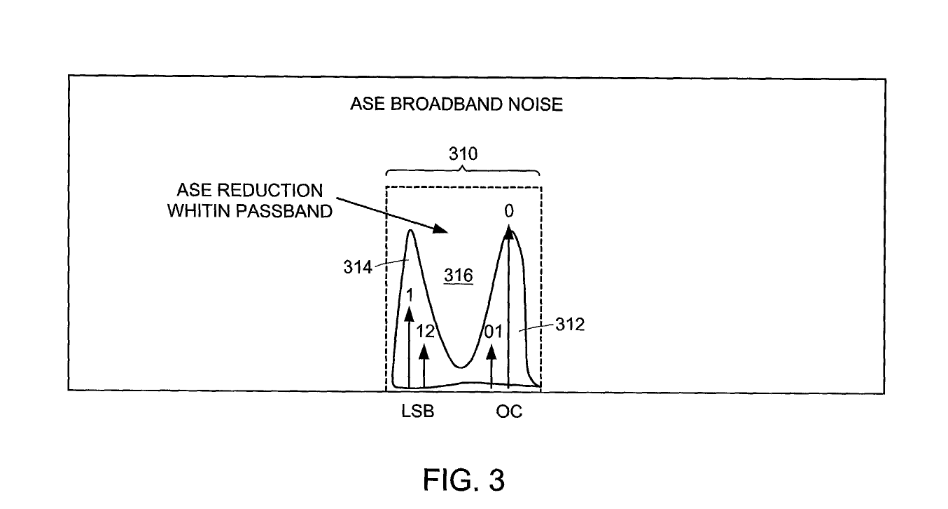

A filter such as a multimode or band-reject filter may be used that is highly tailored to passing a valid signal while rejecting noise. FIG. 3 depicts an example effect of an example reshaped optical pass band filter that can be used for removing more ASE noise power from the signal pass band. In particular, as shown in FIG. 3, since the filter's pass band shape has a “rabbit ears” shape 310, the filter passes much less ASE between spectral components “12” and “01” than is passed by a rectangular pass band shape. The rabbit ears shape 310 includes dual domes 312, 314, overlapping or joined at the bottom, with a notch 316 therebetween. The dual domes may be the result of the filter having multiple modes, and each of the dual domes may be sufficiently high and sufficiently spectrally wide to capture (or substantially capture) the OC and one side band. The notch may have a spectral width approximately equal to the frequency difference between the OC and the side band.

As shown in FIG. 8, a filter (e.g., a having the pass band shape depicted in FIG. 3) may be placed inside an optical regenerator or in front of a receiver on a per lambda (i.e., per channel) basis. (In an optical communication system such as a WDM system, each fiber can have many different channels, each channel being at a different optical center frequency or wavelength, known as “lambda”.)

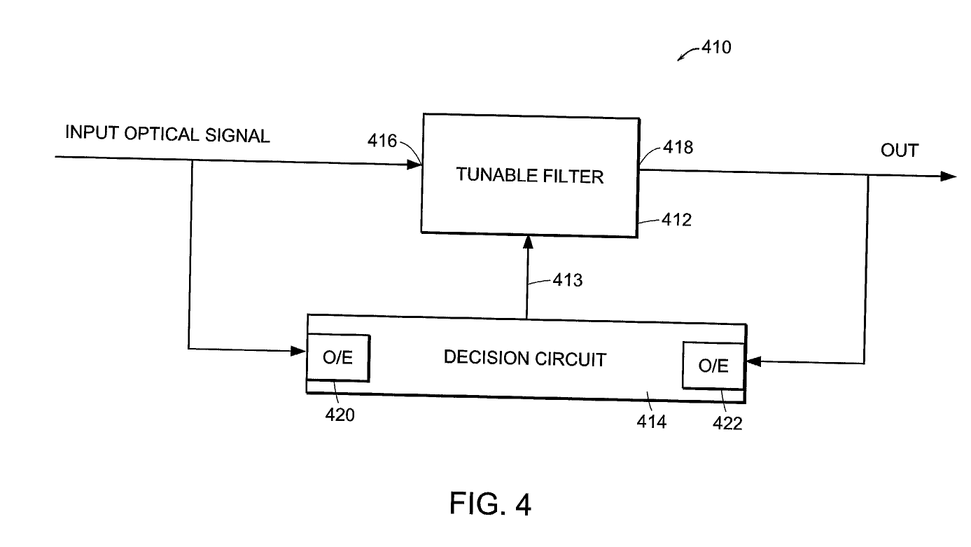

FIG. 4 shows a block diagram of an optical transmission system 410 according to an embodiment of the present invention. System 410 may have some or all of the characteristics of optical signal handling techniques disclosed in one or more of the following patent applications, each of which is hereby incorporated herein by reference in its entirety: U.S. patent application Ser. No. 10/052868, filed Jan. 16, 2002; U.S. patent application Ser. No. 10/053478, filed Jan. 16, 2002; U.S. patent application Ser. No. 10/050635, filed Jan. 16, 2002; U.S. patent application Ser. No. 10/050751, filed Jan. 16, 2002; U.S. patent application Ser. No. 10/050641, filed Jan. 16, 2002; U.S. patent application Ser. No. 10/050749, filed Jan. 16, 2002; and U.S. patent application entitled “FORMING OPTICAL SIGNALS HAVING SOLITON PULSES WITH CERTAIN SPECTRAL BAND CHARACTERISTICS, which is being filed simultaneously herewith.

System 410 includes a tunable infinite impulse response (IIR) filter 412, such as a rotatable etalon, that can shift its center frequency, e.g., by rotation, upon command signals 413 from a Decision Circuit (DS) 414 that may include a microprocessor. Portions of the optical signals are tapped off (e.g., by couplers) from both optical input 416 and output 418 parts of filter 412 and are detected electronically by the DS through the use of Optical to Electrical converters (O/Es) 420, 422 (e.g., photodiodes). The pass band of the filter can be set to pass only an optical carrier and two data sidebands (a DSB signal), or carrier and one data sideband (an SSB signal), or no carrier and two data sidebands (a CSRZ signal). Components including filter 412, the DS, the couplers, and converters 420, 422 may have some or all of the characteristics described in one or more of the patent applications incorporated by reference above.

Preferably, the spectral pass band of transmission system 410 has a flat top rectangular shape, or a rabbit-ear shape as shown in FIG. 3. Multi-cavity etalon structures can be used to create such spectral pass band shapes. Pertinent principles are described in H. van de Stadt and J. M. Muller, “Multimirror Fabry-Perot interferometers,” J. Opt. Soc. Am. A, 2, pp. 1363 et seq., 1985.

Referring to FIG. 4, when the center frequency of the incoming optical signal shifts (e.g., due to drift or purposeful alteration), the DS detects the shift by detecting a change in optical power received from tapping output 418. DS causes filter 412 to tune its center frequency to the new center frequency. The DS also monitors the signal received from tapping input 416 to determine whether the change in output tap power was due to a change in input optical power to the device. If so, it is determined that the change in output optical power was not due to a shift in the center frequency of the incoming optical signal, and no resulting action is taken to tune the filter.

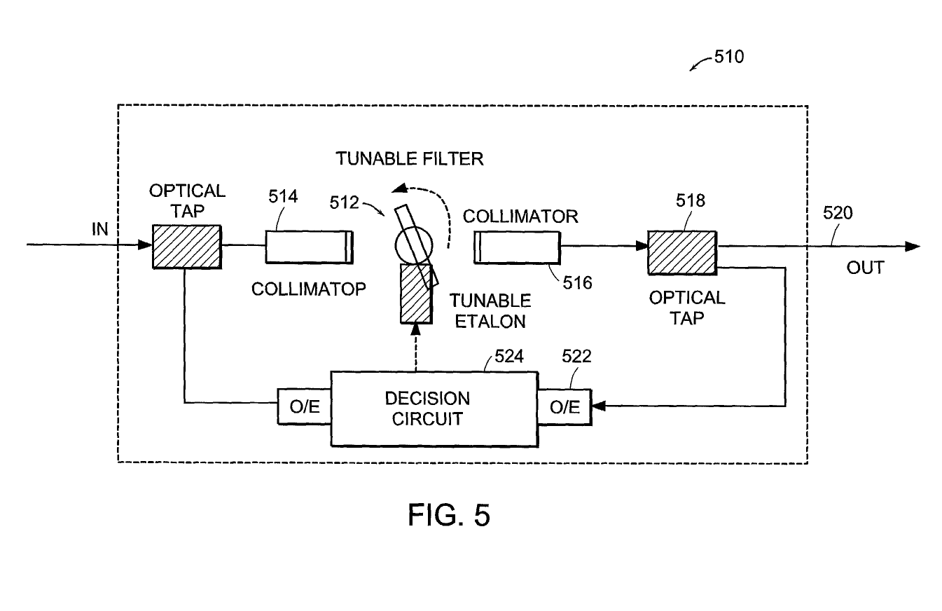

FIG. 5 shows an embodiment 510 of system 410. Embodiment 510 uses a bulk optics approach (i.e., a free space beam propagation technique) that may have some or all of the characteristics described in one or more of the patent applications incorporated by reference above. A high finesse Fabry perot etalon 512 is disposed between a first collimator 514 and a second collimator 516.

Etalon 512 is responsible for establishing the pass band, which allows only certain frequencies of light to pass, centered about a center frequency of the positioned etalon. The pass band width is substantially fixed due to results of the filter design such as the thickness of the etalon and the optical properties of the material used. However, the center frequency of the filter's pass band can shift and be adjusted, by rotating the etalon. By rotating the etalon, the effective thickness of the etalon through which light passes changes causing the center frequency of the pass band to shift and allowing different frequencies to pass through the etalon. In certain preferred embodiments, a multi-mirror etalon is used. Such an etalon may be used to create a more rectangular pass band shape.

Collimator 516 receives the passed optical signals from the etalon and provides them to optical tap 518. Optical tap 518 (e.g., a beam splitter) receives the “tuned” signal and provides an output signal, which may be transmitted onto an optical fiber 520, and an identical feedback optical signal which is received by an optical-to-electrical converter 522, such as a photo diode detector. Converter 522 then provides an electrical version of the signal to a decision circuit 524. Circuit 524, among other things, is responsible for tuning the filter by causing the etalon 512 to rotate. Circuit 524 may detect the energy or power of the feedback signal. In certain embodiments, the amount of energy or power is at maximum when the filter is tuned to capture as much of the optical signal (e.g., SSB signal) as will fit within the pass band of the filter.

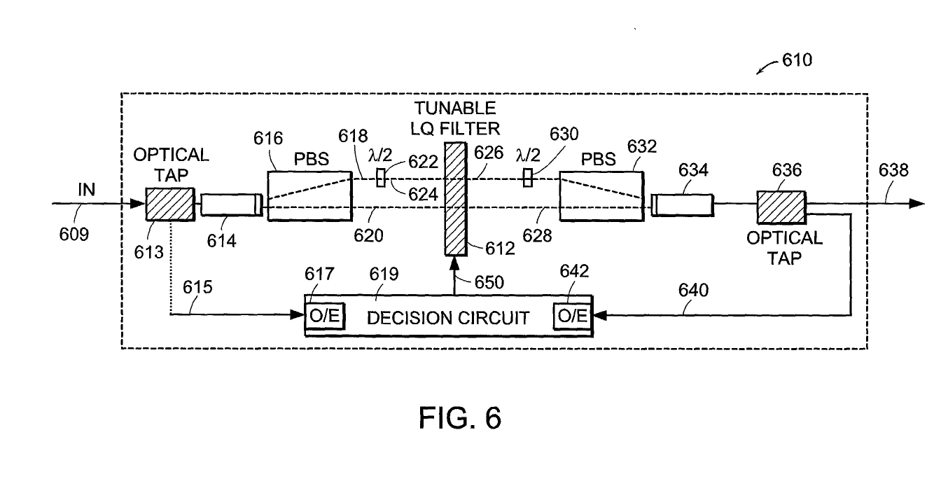

FIG. 6 illustrates another embodiment 610 of system 410. Embodiment 610 uses an electronically tunable liquid crystal Fabry-Perot filter 612 that may have some or all of the characteristics described in one or more of the patent applications incorporated by reference above. Optical signals of arbitrary polarization on link 609 are received by optical tap 613 which provides input signals to first collimator 614 and a tap signal on optical link 615 to O/E 617 of decision circuit 619. Collimator 614 transmits the input signals to first polarization beam splitter (PBS) 616 which divides the light into two paths 618, 620. Light on path 618 passes through first half wave plate 622 so that light on paths 620 and 624 have states of polarization that are aligned to the optical axis of liquid crystal cell 612. Since the liquid crystal Fabry-Perot filter 612 is a polarization sensitive element, aligning the light allows it to be tuned by the filter. The filter light is emitted as paths 626, 628 which are recombined into the output fiber using a second half wave plate 630, second PBS 632 and second collimator 634. Optical tap 636 receives the optical signal from collimator 634 and provides the output signal on link 638 and provides a feedback signal on optical link 640 to O/E 642 of decision circuit 619. The O/Es 617, 640, the decision circuit 619, and other components may have some or all of the characteristics described in one or more of the patent applications incorporated by reference above. Electrical stimulus on control line 650 causes the filter 612 to change its filtration properties and thus allows the filter to track the wandering center frequency of the signals on link 609. For example, the index of refraction of the filter 612 changes in response to electrical stimulus.

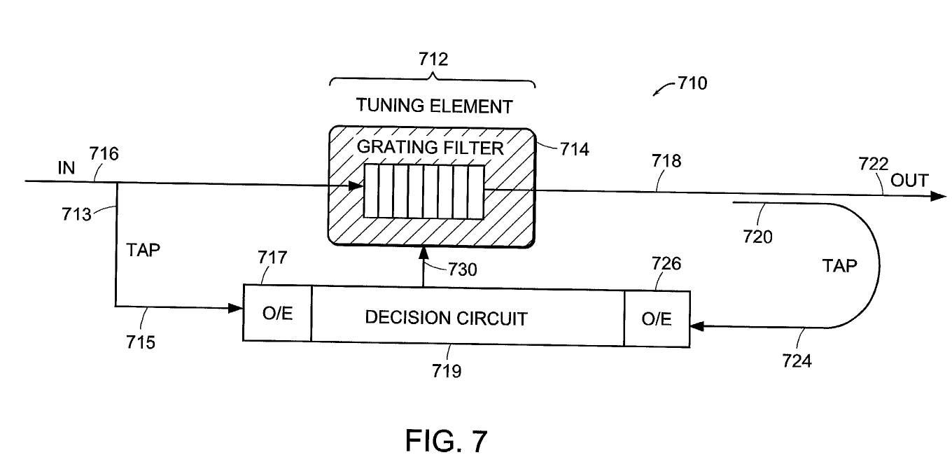

FIG. 7 shows an embodiment 710 of system 410. Embodiment 710 includes a tuning element 712 that includes a grating filter 714. Grating filter 714 may have some or all of the characteristics described in one or more of the patent applications incorporated by reference above. Optical signals are received from link 716 by tap 713 which provides input signals to grating filter 714 and a tap signal on optical link 715 to O/E 717 of decision circuit 719. Grating filter 714 operates to provide filtration on the input signals so that output signals having frequencies of interest pass through the grating on link 718. The output signals are received by tap 720 which provides output signals on link 722 and provides feedback signals on link 724 to O/E 726. The tap and feedback signals are received by O/Es 717, 726 which provide respective electrical versions thereof to decision circuit 719. The decision circuit 719 may use control signal 730 to tune the grating filter 714 and/or to cause the center frequency of the pass band of grating filter 714 to shift.

Filter Tuning

Regarding detection of frequency shifts, if the center frequency of a channel changes, the channel's signal may drift partially or entirely out of the pass band of the filter. Where such drifting out occurs, the output signal of the filter becomes attenuated, which attenuation is manifested in the feedback signal and is detected by the O/E and decision block. In such a case, the decision block acts to tune the filter in response to the frequency shift so that the pass band of the filter more closely matches the new center frequency of the channel. The decision block may also monitor the input signal of the filter to help determine whether the attenuation, if any, in the output signal corresponds to attenuation in the input signal. If it is determined that the attenuation detected in the output signal output corresponds to attenuation in the input signal (rather than a drifting out of the pass band), the filter may not be tuned.

Variations

In connection with the above, the transmission technology may be modified in many ways. For example, one or more finite impulse response filters (FIRs), e.g., as described in one or more of the patent applications incorporated by reference above, may be used in addition to or in place of filters described above, e.g., to help prevent or reduce intersymbol interference (ISI). For example, a non-tracking and/or non-tunable filter may be used, e.g., where the optical signal is highly stable. For example, arrangements described above were illustrated with single filtering devices (e.g., filters) for the most part to avoid clutter. For example, the filters may be implemented as a cascaded arrangement of filters as well. Moreover, though not shown in the FIGS. to avoid clutter, gaining elements may be incorporated into the implementations, e.g., to compensate for any insertion loss from various components of the implementations. For example, the insertion loss of a device may be compensated by Erbium doped optical fiber amplifiers or the like, which may be placed before, after or within a filter block.

The transmission technology may use, in whole or in part, one or more of the filtration techniques described in one or more of the patent applications incorporated by reference above, e.g., for noise reduction or for another purpose.

It will be further appreciated that the scope of the present invention is not limited to the above-described embodiments, but rather is defined by the appended claims, and that these claims will encompass modifications of and improvements to what has been described.

What is claimed is:

1. An optical signal communication system comprising:
an optical signal transmitter;
an optical signal regenerator communicating with the optical signal transmitter and having an optical signal amplifier that produces optical signal noise;
an optical signal receiver communicating with the optical signal regenerator; and
an optical signal filtering device including a signal analyzer being responsive to a detected change in the optical signal;
wherein the optical signal filtering device is configured to pass a single side band optical signal, the optical signal filtering device has filtering characteristics for filtering out the optical signal noise, and the optical signal filtering device is responsive to the signal analyzer to alter the filtering characteristics based on the detected change.

2. The system of claim 1, wherein the optical signal amplifier produces Amplified Spontaneous Emission noise, and the optical signal filtering device has filtering characteristics for filtering out Amplified Spontaneous Emission noise.

3. The system of claim 1, wherein the detected change includes a changed frequency characteristic.

4. The system of claim 1, wherein the detected change includes an changed center frequency.

5. The system of claim 1, wherein the optical signal filtering device is responsive to the signal analyzer to alter the center frequency of the optical signal filtering device.

6. The system of claim 1, wherein the optical signal filtering device is responsive to the signal analyzer to alter the pass band of the optical signal filtering device.

7. The system of claim 1, wherein the signal analyzer is responsive to a consequence of the detected change.

8. The system of claim 1, wherein the signal analyzer is responsive to a change in power in the output of the optical signal filtering device.

9. The system of claim 1, wherein the optical signal filtering device includes a rotatable etalon.

10. The system of claim 1, wherein the signal analyzer includes an optical to electrical converter.

11. The system of claim 1, wherein the signal analyzer is responsive to the output of the optical signal filtering device.

12. The system of claim 1, wherein the signal analyzer is responsive to the input to the optical signal filtering device.

13. The system of claim 1, wherein the optical signal filtering device includes a Fabry perot etalon.

14. The system of claim 1, wherein the optical signal filtering device includes an electronically tunable liquid crystal Fabry-Perot filter.

15. The system of claim 1, wherein the optical signal filtering device includes a grating filter.

16. The system of claim 1, wherein the optical signal filtering device includes a mechanically tunable filter.

17. The system of claim 1, wherein the optical signal filtering device includes an electronically tunable filter.

18. The system of claim 1, wherein the optical signal filtering device has tunable pass band characteristics.

19. The system of claim 1, wherein the optical signal amplifier includes a Raman-Doped Fiber Amplifier.

20. The system of claim 1, wherein the optical signal amplifier includes an Erbium-Doped Fiber Amplifier.

21. An optical signal communication system comprising:
an optical signal transmitter;
an optical signal regenerator communicating with the optical signal transmitter and having an optical signal amplifier that produces optical signal noise;
an optical signal receiver communicating with the optical signal regenerator; and
an optical signal filtering device including a multimode filtering device, wherein the optical signal filtering device is configured to pass a single side band optical signal and the optical signal filtering device has filtering characteristics for filtering out the optical signal noise.

22. The system of claim 21, wherein the multimode filtering device includes a Fabry perot etalon.

23. The system of claim 21, wherein the multimode filtering device has a pass band shape having dual domes with a notch therebetween.

24. The system of claim 21, wherein the multimode filtering device includes a grating filter.

25. The system of claim 21, wherein the multimode filtering device includes a mechanically tunable filter.

26. The system of claim 21, wherein the multimode filtering device includes an electronically tunable filter.

27. The system of claim 21, wherein the multimode filtering device has a pass band shape having dual domes, each of the dual domes being sufficiently high and sufficiently spectrally wide to capture the OC and one side band of the single side band optical signal.

28. An optical signal communication system comprising:
an optical signal device receiving an optical signal, the optical signal device including:
an optical signal filtering device having a signal analyzer being responsive to a detected change in the optical signal, wherein the optical signal filtering device is configured to pass a single side band optical signal, the optical signal filtering device has filtering characteristics for filtering out optical signal noise, and the optical signal filtering device is responsive to the signal analyzer to alter the filtering characteristics based on the detected change.

29. The system of claim 28, wherein the optical signal device serves as an optical signal regenerator.

30. The system of claim 28, wherein the optical signal device serves as an optical signal receiver.

31. The system of claim 28, wherein the optical signal filtering device has filtering characteristics for filtering out Amplified Spontaneous Emission noise.

32. An optical signal communication system comprising:
an optical signal device receiving an optical signal, the optical signal device including:
an optical signal filtering device having a multimode filter, wherein the optical signal filtering device is configured to pass a single side band optical signal and the optical signal filtering device has filtering characteristics for filtering out optical signal noise.

33. The system of claim 32, wherein the optical signal device serves as an optical signal regenerator.

34. The system of claim 32, wherein the optical signal device serves as an optical signal receiver.

35. The system of claim 32, wherein the multimode filtering device includes a Fabry perot etalon.

36. The system of claim 32, wherein the multimode filtering device has a pass band shape having dual domes with a notch therebetween.

37. The system of claim 32, wherein the multimode filtering device includes a grating filter.

38. The system of claim 32, wherein the multimode filtering device includes a mechanically tunable filter.

39. The system of claim 32, wherein the multimode filtering device includes an electronically tunable filter.

40. The system of claim 32, wherein the multimode filtering device has a pass band shape having dual domes, each of the dual domes being sufficiently high and sufficiently spectrally wide to capture the OC and one side band of the single side band optical signal.

41. A method for use in optical signal transmission, comprising:
transmitting an optical signal;
optically amplifying the optical signal;
optically filtering the optical signal to reject optical noise, the optical filtering being configured to pass a single side band optical signal;
detecting a change in the optical signal;
altering the characteristics of the optical filtering based on the detected change; and
receiving the optical signal.

42. The method of claim 41, wherein the optical noise includes Amplified Spontaneous Emission noise, and the optical filtering filters out Amplified Spontaneous Emission noise.

43. The method of claim 41, wherein the detected change includes a changed frequency characteristic.

44. A method for use in optical signal transmission, comprising:
transmitting an optical signal;
optically amplifying the optical signal;
applying multimode filtering to optically filter the optical signal to reject optical noise, wherein the multimode filtering is configured to pass a single side band optical signal; and
receiving the optical signal.

45. The method of claim 44, wherein the optical noise includes Amplified Spontaneous Emission noise, and the optical filtering filters out Amplified Spontaneous Emission noise.

46. The method of claim 44, wherein the multimode filtering uses a Fabry perot etalon.

47. The method of claim 44, wherein the multimode filtering has a pass band shape having dual domes with a notch therebetween.

48. The method of claim 44, wherein the multimode filtering uses a grating filter.

49. The method of claim 44, wherein the multimode filtering uses a mechanically tunable filter.

50. The method of claim 44, wherein the multimode filtering has a pass band shape having dual domes, each of the dual domes being sufficiently high and sufficiently spectrally wide to capture the OC and one side band of the single side band optical signal.

51. A method for use in optical signal transmission, comprising:
optically amplifying an optical signal;
optically filtering the optical signal to reject optical noise, wherein the optical filtering is configured to pass a single side band optical signal;
detecting a change in the optical signal; and
altering the characteristics of the optical filtering based on the detected change.

52. The method of claim 51, wherein an optical signal regenerator performs the optical amplifying.

53. The method of claim 51, wherein an optical signal receiver performs the optical amplifying.

54. The method of claim 51, wherein the optical noise includes Amplified Spontaneous Emission noise, and the optical filtering filters out Amplified Spontaneous Emission noise.

55. The method of claim 51, wherein the detected change includes a changed frequency characteristic.

56. A method for use in optical signal transmission, comprising:
optically amplifying an optical signal; and
applying multimode filtering to optically filter the optical signal to reject optical noise, wherein the optical filtering is configured to pass a single side band optical signal.

57. The method of claim 56, wherein the optical noise includes Amplified Spontaneous Emission noise, and the optical filtering filters out Amplified Spontaneous Emission noise.

58. The method of claim 56, wherein the multimode filtering uses a Fabry perot etalon.

59. The method of claim 56, wherein the multimode filtering has a pass band shape having dual domes with a notch therebetween.

60. The method of claim 56, wherein the multimode filtering uses a grating filter.

61. The method of claim 56, wherein the multimode filtering uses a mechanically tunable filter.

62. The method of claim 56, wherein the multimode filtering has a pass band shape having dual domes, each of the dual domes being sufficiently high and sufficiently spectrally wide to capture the OC and one side band of the single side band optical signal.
